(19) United States
(12) Patent Application Publication
(10) Pub. No.: US 2002/0126867 A1
(43) Pub. Date: Sep. 12, 2002

(54) Flexible ribbon speaker

(76) Inventor: Eliezer Aizik, Motza Ilit (IL)

Correspondence Address: DR. MARK FRIEDMAN LTD., c/o Bill Polkinhorn - Discovery Dispatch, 9003 Florin Way, Upperlboro, MD, 20772, US

(21) Appl. No.: 09/799,588

(22) Filed: Mar. 7, 2001

(51) Int. Cl. H04R 25/00; H04R 9/06

(52) U.S. Cl. 381/399; 381/431; 381/176

(57) ABSTRACT

A flexible ribbon speaker is disclosed. A flexible conductive membrane is placed within an appropriately shaped magnetic field formed by a flexible magnet assembly in such a way that current passing through the membrane interacts with the magnetic field, causing the membrane to vibrate and produce sound. The design of the membrane and of the magnet assembly, along with additional structural elements allows the speaker to be bent. Due to its flexibility, the ribbon speaker of the invention can be located in places that were hitherto inconvenient.

### FIELD AND BACKGROUND OF THE INVENTION

The present invention relates to acoustic transducer systems, and more specifically, to flexible ribbon speakers.

There exist many types of speakers, devices that convert electrical signals to sound. One type of speaker that is exceptionally popular amongst music connoisseurs is the ribbon speaker. Ribbon speakers operate by passing the output current I of an amplifier through conductors placed in a magnetic field B. As a result of the force F=I×B generated, the conductors vibrate, transducing the electrical signal to an acoustic signal.

The operation of a ribbon speaker can best be understood with reference to FIG. 1. The ribbon speaker 10 comprises a substantially planar membrane 12 supported within a rigid frame 14 and disposed within magnetic field 16 produced by two magnets 18a and 18b. In FIG. 1, the north pole of magnet 18a faces the thin edge of membrane 12 and is indicated by the notation “N”. The south pole of magnet 18b is hidden from view in FIG. 1, but also faces the thin edge of membrane 12 and opposes the north pole of magnet 18a. Since the opposite poles of the magnets face each other, magnetic field 16 is horizontal and parallel to the surface of membrane 12. Membrane 12 is conductive. When current 20, corresponding to an audio signal, passes through membrane 12, force 22 is produced, causing membrane 12 to vibrate, producing acoustic energy.

When designing a membrane, a number of factors must be considered. To reduce the amount of heat generated and to generate the maximal force at a given potential, electrical resistance should be low. The mass of the membrane should be low for maximal conversion efficiency and greatest response. Typical membranes, such as in U.S. Pat. No. 4,550,228, are aluminum or beryllium foils. There are membranes made of lightweight nonconductive sheets with conductors cemented to their surfaces, as described in U.S. Pat. No. 3,919,499 or coated with a conductive material. Multilayer membranes have been described in U.S. Pat. No. 5,212,736 and in U.S. Pat. No. 5,953,438.

The greatest disadvantage of the ribbon speakers known to the art is that they are heavy constructions, having massive rigid frames. Ribbon speakers are thus generally inappropriate for use in motor vehicles where they may be considered a safety hazard. Similarly, ribbon speakers are not unobtrusive. When placed in a home, an interior designer must plan the arrangement of the home around the ribbon speakers. Ribbon speakers are expensive and thus not readily available to the general public.

It would be highly advantageous to have a ribbon speaker that is cheaper to produce than existing ribbon speakers. It would be advantageous that such a ribbon speaker would have a structure that gives more freedom to designers to place the ribbon speaker as desired.

### SUMMARY OF THE INVENTION

The above and other objectives are achieved by the flexible ribbon speaker provided by the present invention.

In general a flexible ribbon speaker 24 of the present invention, depicted in FIG. 2a, is made up of two parts: a flexible magnet assembly 26 and a flexible planar membrane 28 of which at least part is electrically conductive. The two parts of speaker 24 must be so associated that a) magnetic field 30 produced by flexible magnet assembly 26 is substantially parallel to the electrically conductive parts of membrane 28; b) conducting elements 32 of membrane 28 are situated in areas where magnetic field 30 is relatively strong; and that c) when speaker 24 is bent, FIG. 2b, conducting elements 32 of membrane 32 remain in the proper position relative to magnetic field 30.

Further, current flowing through the membrane at any point is preferably perpendicular to the magnetic field produced by the flexible magnet assembly.

In some instances the third requirement leads to the necessity of adding structural elements to hold the membrane in the proper position. In other instances, the requirement that the magnetic field be substantially parallel to the membrane leads to the necessity of adding structural elements to limit the flexibility of the speaker in the direction parallel to the magnetic field.

Although many possibilities exist, the flexible magnet assembly is most preferably selected from one of two main types of assemblies.

The first preferable magnet assembly is an arrangement of flexible magnets. Flexible magnets are well known to one skilled in the art, and are usually made of magnetic materials such as ferrites or Nd—Fe—B mixtures (e.g. Magnequench made by Delco Remy a division of General Motors (Anderson, Ind.)) dispersed in a flexible matrix such as rubber or polyvinylchloride. Flexible magnets are commercially available in many shapes and sizes, for instance, from The Electrodyne Company (Batavia, Ohio) or Group Arnold (Marengo, Ill.).

The second preferred type of magnet assembly is an arrangement of non-flexible magnets on a non-magnetic holder. In the arrangement depicted in FIG. 3, the holder is a linear chain 34 made of links 36 to which a plurality of magnets 38 is attached in a row along the length of chain 34. Chain 34 is most preferably a chain that is inflexible in one direction, such as a motorcycle drive chain. In contrast, in the arrangement depicted in FIG. 4, the holder is a flexible two-dimensional construction 40, for instance a wire mesh web such as a chain-link fence, on which a plurality of magnets 42 is attached in the form of a two-dimensional array of magnets. Another possibility is that 40 is a flexible sheet or a woven fabric such as cloth to which magnets 42 are attached.

The membrane used for a speaker of the present invention can be any one of the membranes with which one skilled in the art is acquainted. In general the membranes are very thin and have a low mass.

A first preferred type of membrane is a conductive sheet, most preferably made of aluminum or beryllium foil (see, for example, U.S. Pat. No. 5,212,736). It is also possible to use a foil or sheet of substantially non-conductive material that is coated or laminated with a conductive material. To lend strength and rigidity along the axis of the membrane that is parallel to the magnetic field and flexibility in the axis that is perpendicular to the magnetic field, it is often advantageous to use a corrugated sheet, film or foil.

A second preferred type of membrane is a non-conductive substrate in the form of a sheet held within the magnetic field. Such a sheet can be a polymer film, for example a polyamide film, as described in U.S. Pat. No. 4,303,711, a polyimide film such as Kapton (E. I. DuPont de Nemours & Co., Inc., Wilmington, Del.)) or a polyester film such as Mylar (E. I. DuPont de Nemours & Co., Inc., Wilmington, Del.). Onto the non-conductive sheet discrete conductive paths, such as aluminum or copper wires are attached, for example, by adhesive. If wires are attached to the membrane, it is most preferable to use flat wires that can dissipate heat efficiently and, due to the I greater contact surface area, are bound more robustly to the membrane.

Further, there are in general two preferred arrangements of the magnet assembly relative to the membrane. The first preferred arrangement is one where the magnet assembly is substantially within the plane defined by the membrane, coplanar and to the sides of the membrane, as depicted in FIG. 2a. The second preferred arrangement is one where the magnet assembly is substantially contained within a plane in front or behind the membrane and parallel to the plane defined by the membrane. In the second preferred arrangement it is often necessary to interpose some structure between the membrane and the magnet assembly to prevent incidental contact between the membrane which may damage the membrane or cause a rustling sound. Such a structure is preferably a soft material such as woven cloth or felt. This structure can be a single sheet or discrete pieces.

### BRIEF DESCRIPTION OF THE DRAWINGS

The invention is herein described, by way of example only, with reference to the accompanying drawings, where:

FIG. 1 (prior art) is a cut-away schematic depiction of a typical ribbon speaker;

FIG. 2a is a general schematic depiction of a speaker of present invention in a flat configuration;

FIG. 2b is a general schematic depiction of the speaker of FIG. 2a in a bent configuration;

FIG. 3 is a schematic depiction of one type of magnet assembly of the present invention, made up of a chain with attached magnets;

FIG. 4 is a schematic depiction of one type of magnet assembly of the present invention, made up of a wire mesh web with an attached two-dimensional array of magnets;

FIG. 5 is a schematic depiction of a speaker of the present invention having a corrugated aluminum membrane flanked by two flexible bar magnets;

FIG. 6 is a partial schematic depiction of a speaker of the present invention having a non-conductive polyamide membrane to which aluminum conductors have been cemented;

FIG. 7a is a partial schematic depiction of a speaker of the present invention having a chain of non-flexible magnets as the magnet assembly;

FIG. 7b is an enlarged view of the U-shaped bracket holding apart the links of the magnetic assembly of FIG. 7a;

FIG. 8 is a partial schematic depiction of a speaker of the present invention having an arrangement of four flexible bar magnets and a Mylar membrane to which a serpentine aluminum conductor has been cemented;

FIG. 9 is a schematic depiction of a speaker of the present invention having a planar magnet with strips of alternating magnetic polarity and a Kapton membrane;

FIG. 10a is a schematic depiction of a speaker of the present invention having a wire mesh web with an attached two-dimensional array of magnets as the magnet assembly, hanging from a ceiling;

FIG. 10b is an enlarged view of the two-dimensional array of magnets of FIG. 10a;

FIG. 11 is a schematic depiction of a speaker of the present invention made up of a perforated flexible sheet to which a plurality of flexible bar magnets is attached, overlain with a Kapton membrane with a serpentine conductive path; and

FIG. 12 is a schematic depiction of a speaker of the present invention made up of a soft material sandwiched between a planar magnet with strips of alternating magnetic polarity and a Kapton membrane with a serpentine conductive path.

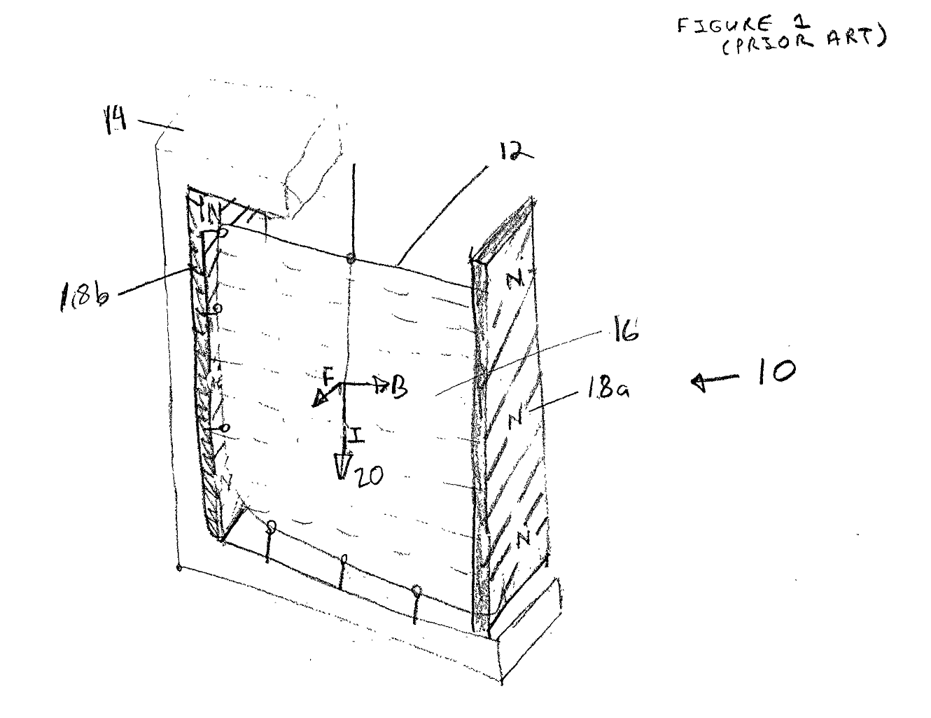

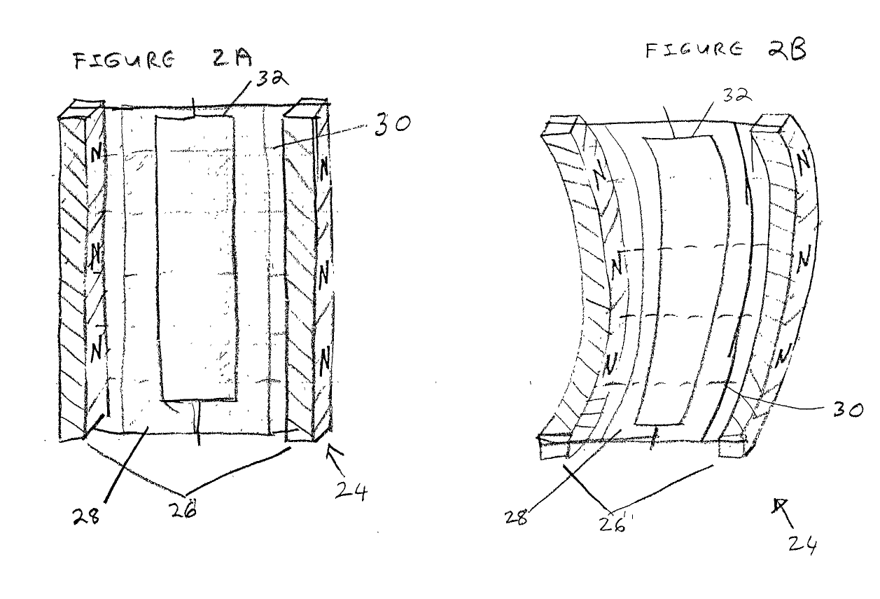

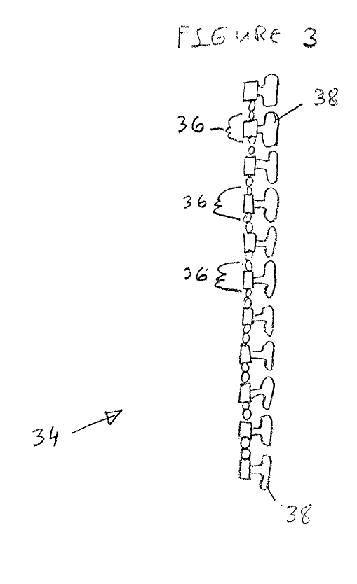

### DESCRIPTION OF THE PREFERRED EMBODIMENTS

The principles and operation of a system according to the present invention may be better understood with reference to the drawings and the accompanying description of the embodiments below, in which like reference numerals refer to like parts throughout all of the figures. It is to be understood that the descriptions below are illustrative, and are not intended to restrict the present invention to the specific details set forth below.

In FIG. 5, a first embodiment of the present invention, speaker 44, is depicted. Membrane 46 is made of corrugated aluminum foil. Along the two vertical edges of membrane 46 are two flexible bar magnets, 48a and 48b. The north pole of magnet 48a and the south pole of magnet 48b are placed to oppose each other, generating a horizontal magnetic field 50. In order to ensure that membrane 46 remains within magnetic field 50, membrane 46 is attached to magnets 48a and 48b with clasps 52. Rigid crosspieces 54a and 54b connect magnet 48a to magnet 48b. This construction leads to speaker 44 being rigid in the vertical dimension but flexible in the horizontal dimension.

An amplifier 56 produces a current 58 that enters speaker 44 through an input plug 60 to membrane 46. Current 58 travels through membrane 46 vertically, interacting with magnetic field 50 to produce a force 62, vibrating membrane 46 to produce sound. The circuit is completed through an output plug 64 back to amplifier 56.

When a force is applied to bend speaker 44 horizontally, the flexibility of membrane 46 and of magnets 48a and 48b allows speaker 44 to bend. Clasps 52 keep membrane 46 within magnetic field 50 and maintain the structural integrity of speaker 44. The rigidity of cross pieces 54a and 54b resists vertical bending of speaker 44.

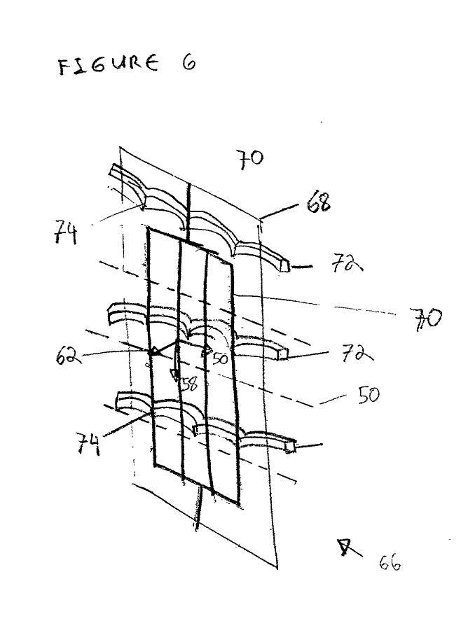

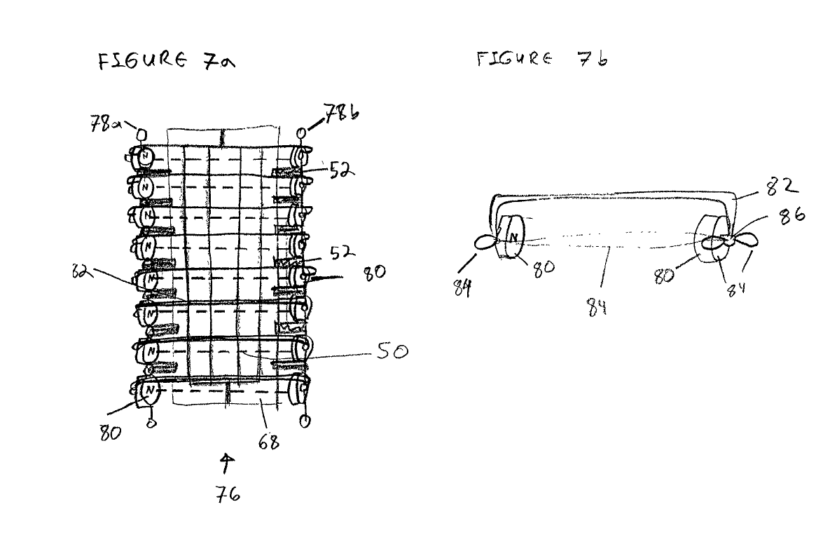

In FIG. 6, a second embodiment of the present invention, a speaker 66 is depicted. Speaker 66 is of the same general construction as speaker 44 excepting that membrane 68 is a non-conductive film of polyamide. For clarity, not shown are bar magnets, clasps and rigid crosspieces resembling magnets 48a and 48b, clasps 52 and rigid crosspieces 54a and 54b respectively. Flat aluminum strips 70 on the surface of membrane 68 conduct current 58 through magnetic field 50 to produce force 62, causing membrane 68 to vibrate.

In FIG. 6, membrane 68 is illustrated as being transparent so as to allow viewing of a plurality of non-conductive rigid secondary cross-members 72. Secondary cross members 72 are connected between the bar magnets of speaker 66 and lend further rigidity to the speaker in the direction perpendicular to magnetic field 50. To ensure that membrane 68 remains properly positioned when speaker 66 is bent, secondary cross-members 72 are fashioned with protrusions 74. Attached to the tips of protrusions 74 is a layer of soft material such as felt to allow non-damaging incidental contact between membrane 68 and protrusions 74.

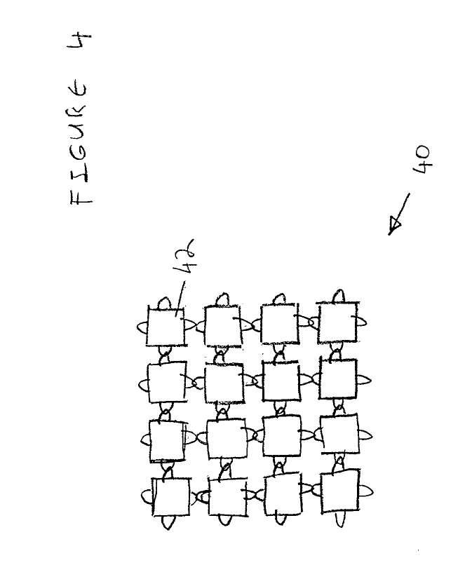

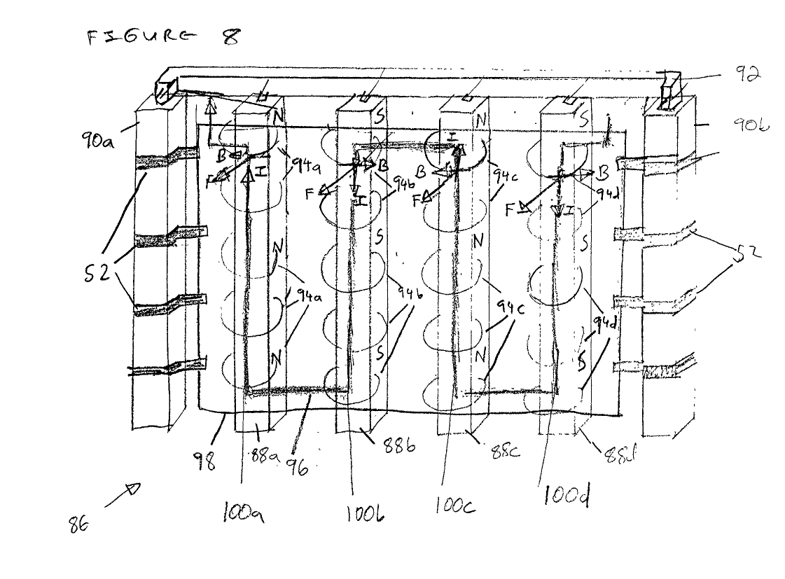

In FIG. 7a, a third embodiment of the present invention, a speaker 76 is depicted. Speaker 76 is of the same general construction as speaker 66, excepting that magnetic field 50 is produced by two chains 78a and 78b. Chains 78a and 78b are fashioned as described above and in FIG. 3. To each of chains 78a and 78b are attached a multiplicity of small non-flexible magnets 80 attached in a row, so that like poles of all magnets 80 of one chain face in the same direction. Chains 78a and 78b are complementary in that the north pole of all magnets 80 attached to chain 78a face towards membrane 68 and the south pole of all magnets 80 attached to chain 78b face towards membrane 78. In this way magnetic field 50 produced by chains 78a and 78b is parallel to membrane 68. Along each of chain 78a and 78b are clasps 52, configured to hold membrane 68.

U-shaped brackets 82 are configured to hold chains 78a and 78b apart despite the attractive force of magnetic field 50. FIG. 7b is a detailed view of chains 78a and 78b Connected by U-shaped bracket 82 are links 84 attached to magnet holder 86 to which a magnet 80 is attached. To ensure that membrane 68 remains within magnetic field 50 when speaker 76 is bent, a plurality of pairs of woolen threads 84 are tied to opposing links 84 and pass on either side of membrane 68.

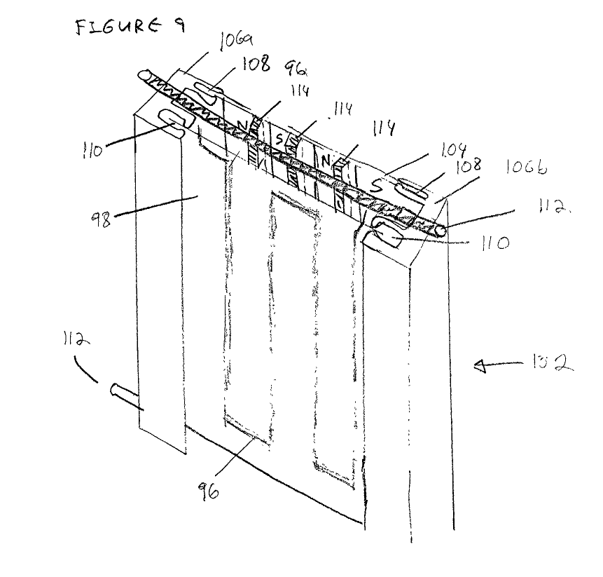

In FIG. 8, a fourth embodiment of the present invention, speaker 86 is depicted. The magnet assembly is made of a plurality of vertically placed flexible bar magnets 88a, 88b, 88c, and 88d flanked by flexible side bars 90a and 90b. A rigid upper crosspiece 92 connects magnets 88a, 88b, 88c, 88d and side-bars 90a and 90b. Not shown are a lower crosspiece and secondary cross-members resembling upper crosspiece 92 and secondary cross-members 72 respectively. Magnets 88a, 88b, 88c and 88d are arranged so that like poles of adjacent magnets face each other. Magnetic field 94 has four important components 94a, 94b, 94c, and 94d. Each component produced starts from one pole of one magnet and ends at the opposite pole of the same magnet. A flat aluminum serpentine conductor 96 is attached to the surface of a non-conducting Mylar membrane 98. Serpentine conductor 96 is fashioned with a plurality of long segments 100a, 100b, 100c and 100d in the vertical dimension, that is perpendicular to magnetic field components 94a, 94b, 94c and 94d and parallel to magnets 88a, 88b, 88c and 88d. Long segments 100a, 100b, 100c and 100d are connected to each other by short segments of serpentine conductor 96. Long segment 100a passes over magnet 88a, long segment 100b passes over magnet 88b, long segment 100c passes over magnet 88c, and long segment 100d passes over magnet 88d. Due to the serpentine shape of conductor 96, current passing through long segments 100a and 100c travels in one direction whereas current passing through long segments 100b and 100d travels in the opposite direction. Due to the orientation of magnets 88a, 88b, 88c and 88d, magnetic field components 94a and 94c produced by magnets 88a and 88c respectively are in one direction whereas magnetic field components 94b and 94d produced by magnets 88b and 88d respectively are in the opposite direction. The forces produced by the product of currents in segments 100a, 100b, 100c and 100d passing through magnetic field components 94a, 94b, 94c and 94d respectively are all in the same direction, leading to effective vibration of membrane 98.

Clasps 52 are connected to sidebars 90a and 90b and are configured to hold membrane 98 in proximity to magnets 88a, 88b, 88c and 88d.

As in speaker 44 depicted in FIG. 5, upper crosspiece 92 and a lower crosspiece (not shown) are configured to connect the top and bottom ends of magnets 88a, 88b, 88c, 88d and sidebars 90a and 90b. Rigid secondary cross-members (not shown) resembling secondary cross-members 72 are attached to sidebars 90a and 90b and are interposed between magnets 88a, 88b, 88c, 88d and membrane 98. This interposition prevents incidental contact between membrane 98 and any one of magnets 88a, 88b, 88c or 88d. As described for speaker 66 and in FIG. 6, on the secondary cross-members are protrusions to which a layer of soft material such as felt is attached to allow non-damaging incidental contact between membrane 98 and the protrusions. The rigidity of upper crosspiece 92, of the lower cross-piece, and of the secondary cross-members prevents speaker 86 from bending in the vertical direction.

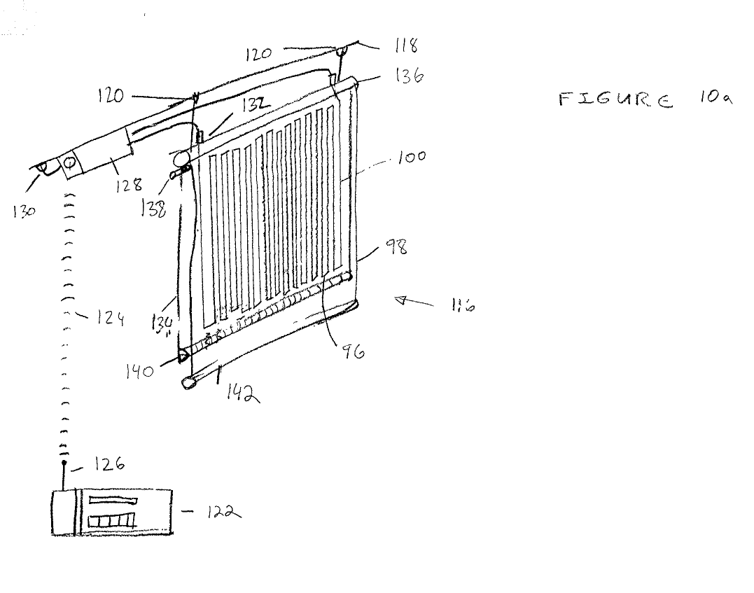

In FIG. 9, a fifth embodiment of the present invention, a speaker 102 is depicted. A one-piece planar magnet 104 is made in accordance with the teachings of U.S. Pat. No. 5,424,703 so that planar magnet 104 is magnetized to have a plurality of parallel strips, where adjacent strips have opposite magnetic polarity. Membrane 98 is a sheet of non-conductive Kapton film with a serpentine conductor 96 passing in a manner analogous to that described for speaker 86 of FIG. 8 through the magnetic fields produced by magnet 104. Flexible holders 106a and 106b are formed each with two parallel grooves, back groove 108 and front groove 110. Magnet 104 is inserted into and held in place by back grooves 108 of holders 106a and 106b whereas membrane 98 is inserted into and held in place by front grooves 110 of holders 106a and 106b. Rigid crosspieces 112a and 112b hold flexible holders 106a and 106b together and prevent bending of speaker 102 along the vertical axis. Disposed on the surface of magnet 104 is a plurality of non-conducting protrusions 114 to prevent incidental contact between magnet 104 and membrane 98 when speaker 102 is bent. The interaction of a current passing through serpentine conductor 96 and the magnetic field of magnet 104 is analogous to that of speaker 86 that has been described hereinbefore and is therefore not discussed in further detail.

In a variation of speaker 102, incidental contact between membrane 98 and magnet 104 is prevented by the interposition of a sheet of a soft material such as felt or fabric instead of non-conducting protrusions 114.

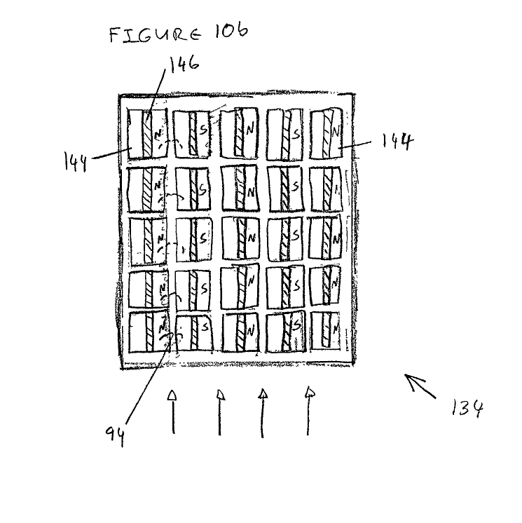

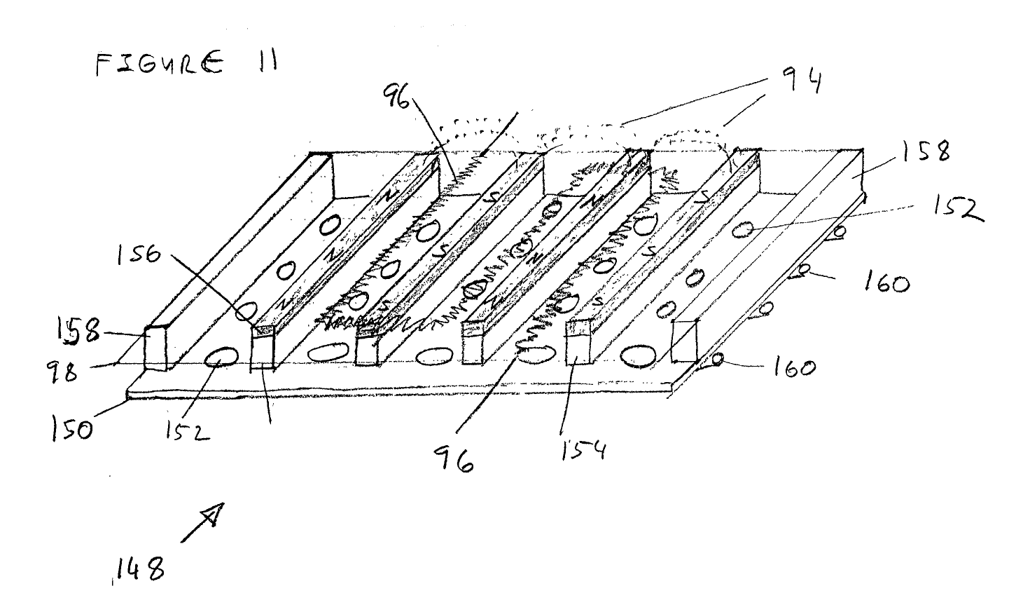

In FIG. 10a, a sixth embodiment of the present invention, a speaker 116 is depicted suspended from a ceiling 118 by hooks 120. A DVD player 122 transmits a music signal 124 through an infrared transmitter 126. An amplifier 128 receives the signal from infrared transmitter 126. Amplifier 128 receives power from an electrical outlet 130 and feeds signal current to speaker 116 through a plug 132, producing music. The shape and the hanging position of speaker 116 from ceiling 118 are esthetically pleasing.

Magnet assembly 134 and membrane 98 are attached to a support rod 136 so that the attachment points of membrane 98 and magnet assembly 134 are close together. In proximity to support rod 136, membrane 98 and magnet assembly 134 are separated by a non-conducting spacer bar 138 and hang downwards as a result of gravitational forces. A non-conducting spacer ridge 140 is attached to the bottom edge of magnet assembly 134 to prevent contact between membrane 98 and magnet assembly 134.

Membrane 98 is made of polyamide and has an attached serpentine conductor 96. Due to the low intrinsic weight of a polyamide film, a weight 142 is added to ensure that membrane 98 hangs downwards and does not crinkle or warp and that membrane 98 is held in contact with spacer bar 138 and spacer ridge 140.

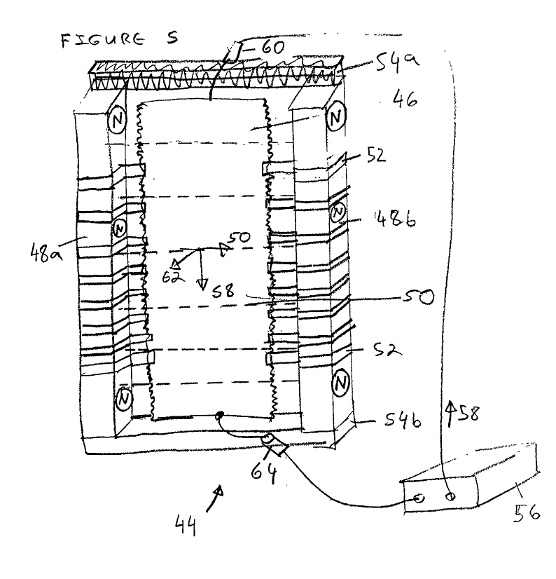

Magnet assembly 134 is a flexible wire mesh web similar to that described in FIG. 4. In FIG. 10b, details of magnet assembly 134 are depicted. Magnets 144 of each vertical column are oriented so that the poles thereof are all oriented in one direction and in opposition to the poles of magnets 144 of an adjacent vertical column. A magnetic field 94 with a component parallel to the plane of magnet assembly 134 is produced over the spaces between two adjacent vertical columns of magnets 144, similar in form to magnetic field 94 of speaker 86 described in FIG. 8.

Serpentine conductor 96 of membrane 98 is made so that long segments 100 pass through magnetic field 94 produced over the spaces between two adjacent vertical columns of magnets 144 indicated in FIG. 10b by arrows. The interaction of a current passing through serpentine conductor 96 and magnetic field 94 is analogous to that of speaker 86 that has been described hereinbefore and is therefore not discussed in further detail.

Attached to each magnet 144 is a non-conducting protrusion 146 made of a soft material. Protrusions 146 prevent membrane 98 from making incidental contact with magnets 144.

Exclusively for illustrative purposes, magnet assembly 134 is a 70 centimeter square, with 729 magnets 144 arranged in a 27 by 27 magnet matrix. Each magnet 144 is a 2 centimeter square. Each magnet 144 is separated from adjacent magnets 144 by 0.5 cm so that each of the 26 vertical spaces between two adjacent vertical columns of magnets 144 is 0.5 cm wide. Serpentine conductor 96 has 26 long vertical segments 100, each long segment 100 located on membrane 98 so that when membrane 98 hangs in position parallel to magnet assembly 134 as illustrated in FIG. 10a, the long segments are within the components of magnetic field 94 that are present above spaces between two adjacent vertical columns of magnets 144.

In FIG. 11 a seventh embodiment of the present invention, a speaker 148 is depicted. On a flexible sheet 150 with a plurality of perforations 152 are attached a plurality of flexible bar magnets 154. Magnets 154 are attached in parallel to each other with one pole facing sheet 150 and the opposite pole facing upwards. Magnets 154 are arranged so that opposite poles of adjacent magnets face upwards so as to produce magnetic field 94 similar to the magnetic fields produced by magnet 104 of speaker 102 as described above and in FIG. 9. To the upper surface of each of magnets 154 is attached a layer of soft material 156. Attached to two opposing ends of sheet 150, parallel to and flanking magnets 154, are two flexible side-bars 158. Attached to side-bars 158, for example by adhesive, is a Kapton membrane 98 (illustrated in FIG. 11 as being transparent). Membrane 98 lies over magnets 154 and makes contact with soft material 156. On membrane 98 is attached a serpentine conductor 96. Membrane 98 is attached to side-bars 158 and lain over magnets 154 in such a way so that long segments 100 of serpentine conductor 96 are located above an area between two magnets 154, a region where magnetic field 94 is substantially parallel to membrane 98. The interaction of a current passing through serpentine conductor 96 and magnetic field of magnet 94 is analogous to that of speaker 86 that has been described hereinbefore and is therefore not discussed in further detail.

To lend rigidity to speaker 148 in the dimension perpendicular to magnets 154, a plurality of rigid plastic bars 160 is attached to the underside of sheet 150.

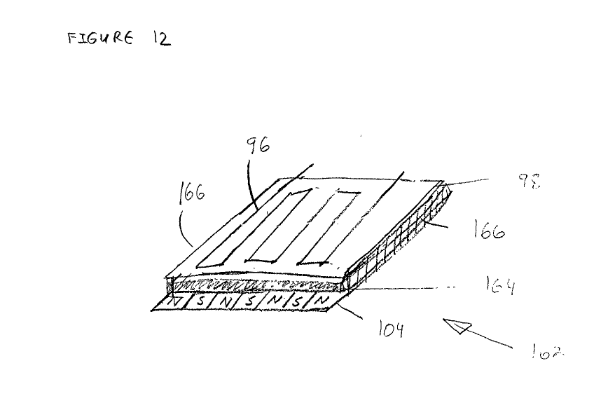

In FIG. 12 an eighth embodiment of the present invention, a speaker 162 is depicted. A one-piece planar magnet 104 having parallel strips of alternating magnetic polarity, similar to magnet 104 of speaker 102 as described above and in FIG. 9. On top of magnet 104 is a sheet of a soft material 164 such as felt or fabric. On top of sheet of soft material 164 is a membrane 98 made of Kapton. The edges 166, parallel to the parallel strips of magnet 104, of magnet 104, soft material 164 and membrane 98 are joined together, for example, by adhesive. Attached to membrane 98 is a serpentine conductor 96. As described for speaker 148, membrane 98 is placed in such a way that long segments 100 of serpentine conductor 96 are located above the area where strips of opposing magnetic polarity of magnet 104 abut. The interaction of a current passing through serpentine conductor 96 and the magnetic field of magnet 104 is analogous to that of speaker 86 that has been described hereinbefore and is therefore not discussed in further detail.

The thickness and compressibility of soft material 164 is chosen so that soft material 164 ensures that there is no incidental contact between magnet 104 and membrane 98.

It is clear to one skilled in the art that speakers 148 and 162 are exceptionally simple and cheap to produce in many sizes and shapes.

While the invention has been described with respect to a limited number of embodiments, it will be appreciated that many variations, modifications and other applications of the invention may be made.

What is claimed is:

1. An electromagnetic transducer comprising:
(a) a flexible membrane at least a portion whereof is electrically conductive in a plane; and
(b) a flexible magnet assembly operationally connected to said flexible membrane so that a magnetic field produced by said flexible magnet assembly is substantially parallel to said membrane at said electrically conductive portion thereof.

2. The electromagnetic transducer of claim 1 further comprising a structural element to effect said operational connection when the electromagnetic transducer is bent.

3. The electromagnetic transducer of claim 2 wherein said structural element includes a plurality of threads mounted substantially parallel to said membrane in pairs, each single thread of said pairs mounted on opposing sides of said membrane.

4. The electromagnetic transducer of claim 1 wherein said component of said magnetic field is substantially perpendicular to said electrically conductive portion of said membrane.

5. The electromagnetic transducer of claim 4 further comprising a rigid structural element configured to oppose bending of the electromagnetic transducer perpendicularly to said electrically conductive portion of said membrane.

6. The electromagnetic transducer of claim 1 wherein said magnet assembly includes at least one flexible magnet.

7. The electromagnetic transducer of claim 6 wherein said at least one flexible magnet includes a plurality of particles of magnetic materials suspended in a flexible substrate.

8. The electromagnetic transducer of claim 7 wherein said magnet assembly is in the form of a flexible magnetic sheet having a plurality of discrete areas of alternating magnetic polarity.

9. The electromagnetic transducer of claim 8 wherein said discrete areas are substantially parallel strips, with adjacent said parallel strips having opposite magnetic polarities.

10. The electromagnetic transducer of claim 1 wherein said magnet assembly includes at least one non-magnetic flexible support onto which at least two magnets are attached.

11. The electromagnetic transducer of claim 10 wherein said magnet assembly includes at least two flexible linear chains and onto each of said at least two linear chains is attached a plurality of magnets.

12. The electromagnetic transducer of claim 1 wherein said magnet assembly includes a flexible surface whereto at least two magnets are attached.

13. The electromagnetic transducer of claim 12 wherein said flexible surface is a wire mesh web.

14. The electromagnetic transducer of claim 12 wherein said flexible surface is a cloth.

15. The electromagnetic transducer of claim 1 wherein all of said membrane is electrically conductive.

16. The electromagnetic transducer of claim 1 wherein said membrane includes a discrete electrically conductive path and an electrically non-conductive substrate.

17. The electromagnetic transducer of claim 16 wherein said discrete electrically conductive path is serpentine.

18. The electromagnetic transducer of claim 1 wherein said membrane and said magnet assembly are substantially coplanar.

19. The electromagnetic transducer of claim 1 wherein said magnet assembly is substantially parallel to and spaced-apart from said membrane.

20. The electromagnetic transducer of claim 19 further comprising a mechanism for preserving said spaced-apart configuration of said membrane and said magnet assembly.

21. The electromagnetic transducer of claim 20 wherein said mechanism is a soft material interposed between said magnet assembly and said membrane.

22. The electromagnetic transducer of claim 21 wherein said soft material is in the form of a sheet.

23. The electromagnetic transducer of claim 21 wherein said soft material is felt.

24. The electromagnetic transducer of claim 21 wherein said soft material is a woven fabric.

25. The electromagnetic transducer of claim 1 further comprising a weight to hold said membrane taut.
